(19) United States
(12) Patent Application Publication
(10) Pub. No.: US 2005/0275357 A1
(43) Pub. Date: Dec. 15, 2005

(54) Liquid crystal display and control method thereof

(76) Inventor: Kyung-shik Lee, Yongin-si (KR)

Correspondence Address: STANZIONE & KIM, LLP, 919 18TH STREET, N.W., SUITE 440, WASHINGTON, DC, 20006, US

(21) Appl. No.: 11/140,980

(22) Filed: Jun. 1, 2005

(30) Foreign Application Priority Data
Jun. 11, 2004 (KR) 2004-43221

(51) Int. Cl. H05B 37/00

(52) U.S. Cl. 315/312

(57) ABSTRACT

An LCD includes an LCD panel to display a picture, a backlight unit disposed in a rear of the LCD panel and having a light guide unit to guide light toward the LCD panel, and first and second lamp units respectively disposed at opposite edges of the light guide unit and each having two or more lamps to emit light toward the light guide unit, a first lamp driver to supply first AC power to drive at least one lamp of the first lamp unit and at least one lamp of the second lamp unit, a second lamp driver to supply second AC power to drive the other lamp of the first lamp unit and the other lamp of the second lamp unit, and a controller to switch on/off supply of the first AC power.

### CROSS-REFERENCE TO RELATED APPLICATIONS

This application claims the benefit of priority under 35 U.S.C. § 119 of Korean Patent Application No. 2004-43221, filed Jun. 11, 2004, in the Korean Intellectual Property Office, the disclosure of which is incorporated herein by reference.

### BACKGROUND OF THE INVENTION

1. Field of the Invention

The present general inventive concept relates to a liquid crystal display (LCD) and a control method thereof, and more particularly, to an LCD and a control method thereof, in which a user adjustable brightness level range of an LCD panel is expanded.

2. Description of the Related Art

An LCD has recently replaced a cathode ray tube (CRT) display because the LCD has advantages, such as, having lower power consumption, and smaller and lighter than the CRT display. These advantages make the LCD a popular choice when used as a monitor for a laptop computer, a desktop computer.

Since such an LCD itself cannot emit light, either an external light is needed to be reflected and passed through an LCD panel or it is necessary to provide a separate light source, i.e., a backlight unit, disposed in a rear of the LCD panel in order to display a picture.

The backlight unit comprises a lamp to emit light, a light guide plate to guide the light emitted from the lamp toward the LCD panel, and optical sheets.

A current trend requires the LCD to have a large sized screen, a relatively small thickness, and a wide view angle, etc. Accordingly, a large sized LCD has been developed and the LCD is now used in various fields requiring a large sized display apparatus, e.g., a wide screen television.

To improve a brightness of the large sized LCD, a lamp is disposed at an edge of a light guide plate of a large sized LCD panel, which is called an edge type LCD panel. In the case of the edge type LCD panel, two or more lamps are respectively disposed at opposite edges among the edges of the light guide plate, and a lamp-driving unit is provided to drive the respective lamps disposed at the opposite edges, thereby responding to requirements for the brightness of the LCD.

FIG. 1 is a control block diagram showing a lamp-driving unit 140 of a conventional edge type LCD. As shown in FIG. 1, two pairs of lamp units 130 are respectively disposed at opposite sides, e.g., at upper and lower side edges of the light guide plate, and driven to operate by driving power supplied from a lamp driving unit 140.

The lamp-driving unit 140 comprises a first lamp driver 141 supplying a driving power to lamps 130a and 130b (hereinafter, referred to as “first lamp” and “second lamp”) disposed at the upper side edges of the light guide plate; a second lamp driver 145 supplying a driving power to lamps 130c and 130d (hereinafter, referred to as “third lamp” and “fourth lamp”) disposed at the lower side edges of the light guide plate; and a controller 148 controlling the first and second lamp drivers 141 and 145.

The first lamp driver 141 comprises a first switching circuit 142 outputting a pulse signal by switching on/off an input direct current (DC) power V_{DC}_{_{—}}_{IN} in response to a first pulse width modulation (PWM) signal from the controller 148; and a first transformer 143 transforming the first pulse signal from the first switching circuit 142 into a first alternating current (AC) power to drive the first and second lamps 130a and 130b, and supplying the first AC power to the first and second lamps 130a and 130b.

Like the first lamp driver 141, the second lamp driver 145 comprises a second switching circuit 146 and a second transformer 147, thereby supplying a second AC power needed to drive the third and fourth lamps 130c and 130d in response to a second PWM signal from the controller 148.

Here, a capacitor C is provided in each secondary side of the first transformer 143 and the second transformer 147, thereby controlling first and second current intensities of the first and second AC powers supplied from each of the first and second transformers 143 and 147.

Further, the controller 148 adjusts the first and second current intensities of the first and second AC powers supplied from the first and second transformers 143 and 147 by controlling a pulse width of the first and second PWM signals to vary according to voltage levels of a control power V_{DC}_{_{—}}_{CNT}, thereby adjusting a light intensity of the first, second, third and fourth lamps 130a, 130b, 130c and 130d. Thus, a brightness of the conventional edge type LCD is adjusted.

Meanwhile, a power sensor 149 senses the first and second current intensities of the first and second AC powers supplied from the first and second transformers 143 and 147. Here, the controller 148 can adjust the first and second current intensities of the first and second AC powers on the basis of the sensed first and second current intensities from the power sensor 149.

FIG. 2 is a graph showing a relation between a voltage level of the control power V_{DC}_{_{—}}_{CNT} supplied to the controller 148 and a brightness level of an LCD panel in the conventional edge type LCD of FIG. 1. Referring to FIGS. 1 and 2, the voltage level of the control power V_{DC}_{_{—}}_{CNT} supplied to the controller 148 ranges from 0V to 5V, and the brightness of the LCD panel is determined in proportion to the voltage level of the control power V_{DC}_{_{—}}_{CNT}.

In addition, the conventional edge type LCD provides various user interfaces (not shown) allowing a user to set display options of a picture displayed on the LCD panel. For example, such a user interface includes an OSD (on screen display). In the case of the OSD, a user can set the display options, such as a brightness, a resolution, a contrast, etc., of the LCD panel by selecting an OSD button provided in a front of the conventional edge type LCD.

However, different users may not want the same display options when setting the display options of a picture displayed on the LCD panel. Therefore, a manufacturer of the LCD has tried to provide a user with display options of which the settable range is larger so as to enable the user to set the display options as the user wants.

### SUMMARY OF THE INVENTION

The present general inventive concept provides an LCD and a control method thereof, to expand a user adjustable brightness level range of an LCD panel is.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an LCD comprising an LCD panel to display a picture thereon a backlight unit disposed in a rear of the LCD panel and comprising a light guide unit to guide light toward the LCD panel, and first and second lamp units respectively disposed at opposite edges of the light guide unit and each having two or more lamps to emit light toward the light guide unit, a first lamp driver to supply a first AC power to drive at least one lamp of the first lamp unit and at least one lamp of the second lamp unit a second lamp driver to supply a second AC power to drive the other lamp of the first lamp unit and the other lamp of the second lamp unit and a controller to switch on/off supply of the first AC power.

The LCD may further comprise a brightness adjuster to output a brightness-adjusting signal to adjust a brightness level of the LCD panel, wherein the controller cuts off the supply of the first AC power when the brightness-adjusting signal of the brightness adjuster is below a predetermined brightness level.

The first lamp driver may comprise a switching circuit to output a pulse signal by switching on/off an input DC power, and a first transformer to receive the pulse signal from the switching circuit and to generate the first AC power, and the controller cuts off the pulse signal outputted from the switching circuit when the brightness-adjusting signal of the brightness adjuster is below the predetermined brightness level.

The controller can control a current intensity of at least one of the first AC power and the second AC power in correspondence to the brightness-adjusting signal outputted from the brightness adjuster and can adjust the brightness level of the LCD panel.

The first lamp driver may comprises a switching circuit to output the pulse signal by switching on/off the input DC power, the first transformer to receive the pulse signal from the switching circuit and to generate the first AC power and a switch to switch on/off the input DC power to be inputted to the switching circuit, and the controller controls the switch to cut off the input DC power being inputted to the switching circuit when the brightness-adjusting signal of the brightness adjuster is below the predetermined brightness level.

The foregoing and/or other aspects and advantages of the present general inventive concept may also be achieved by providing a method of controlling an LCD comprising an LCD panel to display a picture thereon, and a backlight unit disposed in a rear of the LCD panel and comprising a light guide unit to guide light toward the LCD panel, and a first and second lamp units respectively disposed at opposite edges of the light guide unit and each having two or more lamps to emit light toward the light guide unit, the method comprising supplying a first AC power to at least one lamp of the first lamp unit and at least one lamp of the second lamp unit to drive the at least one lamp of the first lamp unit and the at least one lamp of the second lamp unit, supplying a second AC power to the other lamp of the first lamp unit and the other lamp of the second lamp unit to drive the other lamp of the first lamp unit and the other lamp of the second lamp unit, outputting a brightness-adjusting signal to adjust a brightness level of the LCD panel, and cutting off the first AC power supplied to at least one lamp of the first lamp unit and at least one lamp of the second lamp unit when the brightness-adjusting signal is below a predetermined brightness level.

The method may further comprise adjusting a current intensity of at least one of the first AC power and the second AC power in correspondence to the brightness-adjusting signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a control block diagram showing a lamp-driving unit of a conventional edge type LCD;

FIG. 2 is a graph showing a relation between a voltage level of the control power V_{DC}_{_{—}}_{CNT} supplied to a controller and a brightness level in the conventional edge type LCD of FIG. 1;

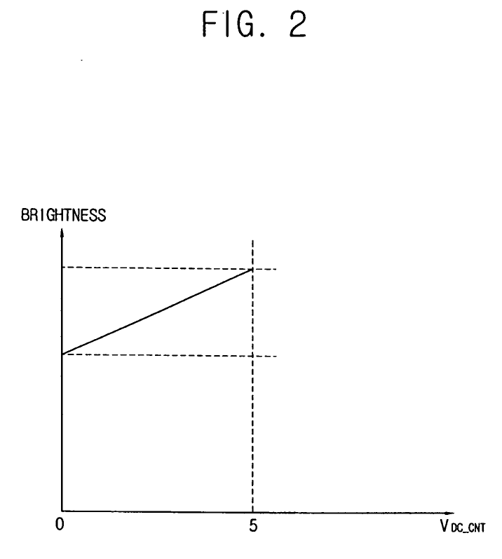

FIG. 3 is an exploded perspective view of an LCD according to an embodiment of the present general inventive concept;

FIG. 4 is a control block diagram of a lamp-driving unit of the LCD of FIG. 3;

FIG. 5 is a control block diagram of a lamp-driving unit of an LCD according to another embodiment of the present general inventive concept;

FIG. 6 is a control flowchart of an LCD according to another embodiment of the present general inventive concept; and

FIG. 7 is a graph showing a relation between a brightness-adjusting signal and a brightness level in the LCD of FIG. 6.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

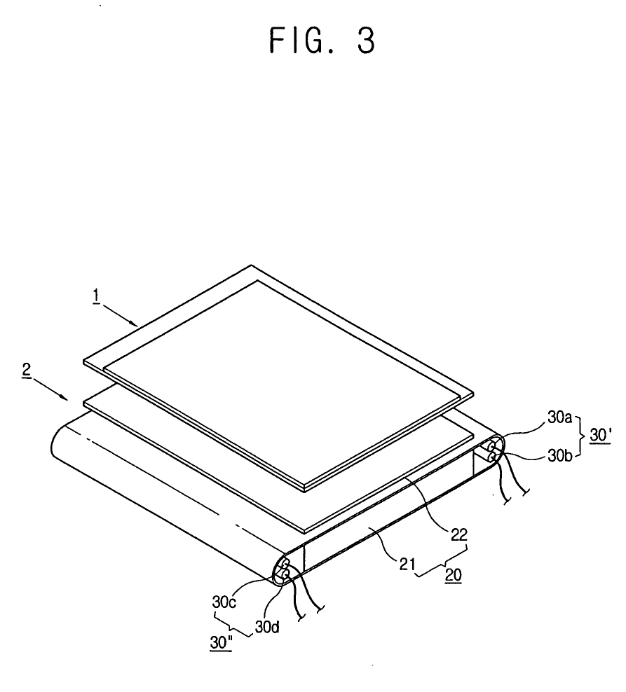

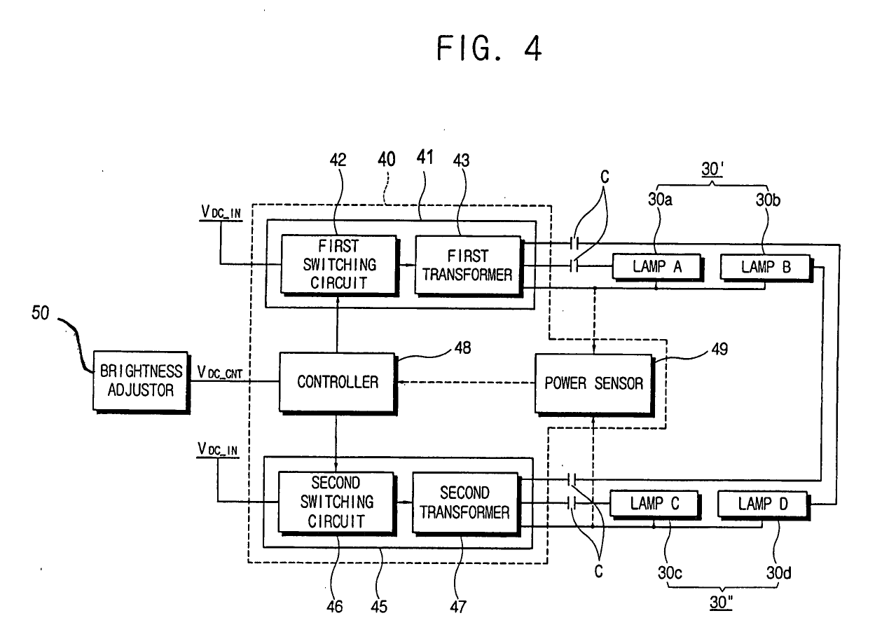

As shown in FIG. 3, an LCD according to an embodiment of the present invention comprises an LCD panel 1 to display a picture thereon, a backlight unit 2 disposed in a rear of the LCD panel 1 and comprising a plurality of lamps 30′ and 30″, and a lamp driving unit 40 (refer to FIG. 4) driving the lamps.

The LCD panel 1 comprises a first plate formed with a switching device and a pixel electrode, a second plate, and a liquid crystal provided between the first and second plate. In the first plate, a video signal goes through a drive integrated chip (IC), such as a source side drive IC, a gate side drive IC, etc., and is transmitted to the switching device of the first plate. At this time, the liquid crystal receives an electrical signal and adjusts light from the backlight unit 2, thereby displaying the picture on the LCD panel 1.

The backlight unit 2 is disposed in the rear of the LCD panel 1 and provides the LCD panel 1 with uniform light. The backlight unit 2 may further comprise a light guide unit 20 to guide light from the plurality of lamps 30′ and 30″ toward the LCD panel 1.

The light guide unit 20 comprises a light guide plate 21 to guide light from the lamp toward the LCD panel 1, and an optical sheet 22 provided between the light guide plate 21 and the LCD panel 1 and including a diffusing plate, a prism sheet, etc., which enhances optical characteristics, such as brightness and the like.

According to an aspect of the present general inventive concept, two or more pairs of lamps 30′ and 30″ can be respectively disposed at edges of opposite sides of the light guide unit 20. The lamps 30′ and 30″ are disposed along longitudinal edges of the light guide unit 20. In this embodiment, the lamp units are disposed at upper and lower edges of the light guide unit 20, respectively.

Hereinbelow, two pairs of lamps 30′ and 30″ provided at the upper and lower edges of the light guide unit 20 will be described by way of an example. Further, a pair of lamps disposed at the upper edge of the light guide unit 20 will be called a first lamp unit 30′, and a pair of lamps disposed at the lower edge of the light guide unit 20 will be called a second lamp 30″. Here, the first lamp unit 30′ comprises a lamp A 30a driven by a first lamp driver 41 (refer to FIG. 4), and a lamp B 30b driven by a second lamp driver 45 (refer to FIG. 4). Also, the second lamp unit 30″ comprises a lamp C 30c driven by the second lamp driver 45, and a lamp D 30d driven by the first lamp driver 41.

FIG. 4 is a control block diagram of the lamp-driving unit 40 of the LCD of FIG. 3. As shown in FIGS. 3-4, the lamp-driving unit 40 comprises the first lamp driver 41, the second lamp driver 45, and a controller 48.

The first lamp driver 41 converts an input DC power V_{DC}_{_{—}}_{IN} into a first AC power. Here, the first AC power is outputted from the first lamp driver 41 as power to drive the lamp A 30a and the lamp D 30d. The second lamp driver 45 converts the input DC power V_{DC}_{_{—}}_{IN} into a second AC power. Here, the second AC power is output from the second lamp driver 45 as power to drive the lamp B 30b and the lamp C 30c.

The first lamp driver 41 comprises a first switching circuit 42 and a first transformer 43. Here, the first switching circuit 42 outputs a first pulse signal by switching on/off the input DC power V_{DC}_{_{—}}_{IN} in response to a first PWM signal from the controller 48. At this time, the first transformer 43 transforms a first pulse signal applied to a primary side thereof into the first AC power, thereby outputting the first AC power through a secondary side thereof. Further, the lamp A 30a and the lamp D 30d are connected in parallel to the secondary side of the first transformer 43, and driven to emit light by receiving the first AC power from the first transformer 43.

The second lamp driver 45 comprises a second switching circuit 46 and a second transformer 47. Here, the second switching circuit 46 outputs a second pulse signal by switching on/off the input DC power V_{DC}_{_{—}}_{IN} in response to a second PWM signal from the controller 48. At this time, the second transformer 47 transforms the second pulse signal applied to a primary side thereof into the second AC power, thereby outputting the second AC power through a secondary side thereof. Further, the lamp B 30b and the lamp C 30c are connected in parallel to the secondary side of the second transformer 47, and driven to emit light by receiving the second AC power from the second transformer 47.

Here, a capacitor C is connected to each secondary side of the first transformer 43 and the second transformer 47, thereby controlling a current intensity of the first and second AC powers.

Further, each light intensity of the lamp A 30a, and the lamp D 30d, and the lamp B 30b and the lamp C 30c varies in correspondence to each current intensity of the first AC power and the second AC power respectively supplied from the secondary sides of the first and second transformers 43 and 47. At this time, the controller 48 adjusts the current intensity of the first and second AC power by controlling a pulse width (“duty”) of the first PWM signal and second PWM signal, respectively applied to the first and second switching circuits 42 and 46. Thus, the brightness of the LCD panel 1 is adjusted.

In addition, the LCD may further comprise a brightness adjuster 50 to output a brightness-adjusting signal V_{DC}_{_{—}}_{CNT} to adjust a level of the brightness of the LCD panel 1. The brightness-adjusting signal V_{DC}_{_{—}}_{CNT} is outputted from the brightness adjuster 50 to the controller 48, and the controller 48 controls the light intensity of the lamp A 30a, the lamp B 30b, the lamp C 30c and the lamp 30d, thereby adjusting the brightness of the LCD panel 1. Here, the controller 48 adjusts the level of brightness of the LCD panel 1 in correspondence to a voltage level of the brightness-adjusting signal V_{DC}_{_{—}}_{CNT} outputted from the brightness adjuster 50.

The brightness adjuster 50 comprises an OSD button allowing a user to input a key signal, and a microcomputer to output the brightness-adjusting signal V_{DC}_{_{—}}_{CNT} having the voltage level corresponding to the key signal of the OSD button. Alternatively, the brightness adjuster 50 may have various configurations as long as it can output the brightness-adjusting signal V_{DC}_{_{—}}_{CNT} having the voltage level corresponding to the user's brightness adjustment.

Further, the controller 48 switches on/off the first AC power supplied from the first lamp driver 41 to the lamp A 30a and the lamp D 30d. The controller 48 switches off the first switching circuit 42 and cuts off the first pulse signal outputted from the first switching circuit 42, thereby preventing the first transformer 43 from outputting the first AC power. Thus, the first lamp unit 30′ and the second lamp unit 30″ can be individually turned off, thereby expanding an adjustable range of the brightness of the LCD panel 1. For example, the controller 48 can turn off the lamp A 30a and the lamp D 30d by cutting off the first AC power.

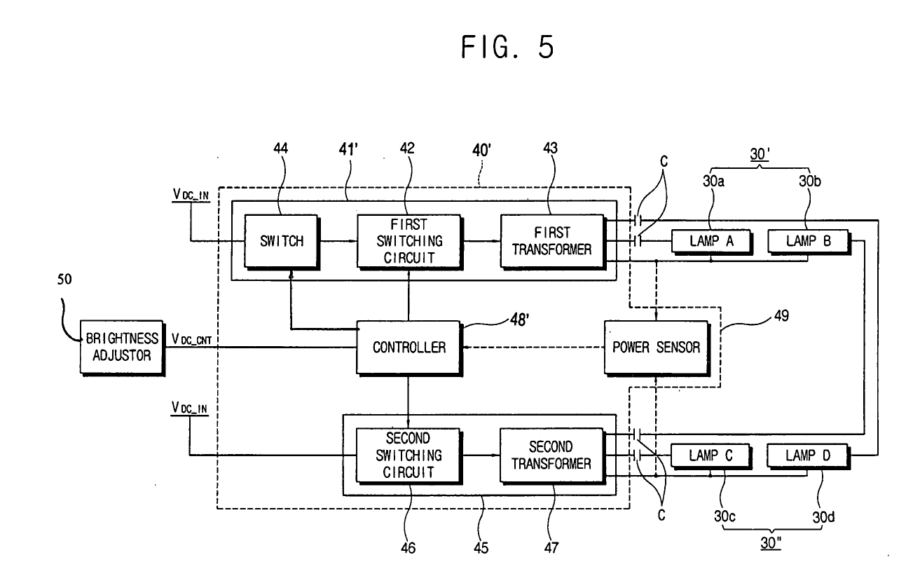

FIG. 5 is a control block diagram of a lamp-driving unit 40′ of an LCD according to another embodiment of the present general inventive concept. In description of the lamp-driving unit 40′ of FIG. 5, like numerals as to the embodiment described in FIG. 4 will refer to like elements, and repetitive descriptions will omitted.

A first lamp driver 41′ of the lamp-driving unit 40′ comprises a switch 44 to switch on/off the DC power V_{DC}_{_{—}}_{IN} inputted to the first switching circuit 42. Here, a controller 48 or 48′ switches on/off the switch 44, thereby supplying or cutting off the first AC power from the first transformer 43 to the lamp A 30a and the lamp D 30d.

The controller 48 or 48′ can switch off the first switching circuit 42 by switching off the switch 44, independently switching off the first switching circuit 42, in order to cut off the first AC power. Hence, wasteful switching operations for the first switching circuit 42 are eliminated while the switch 44 is switched off.

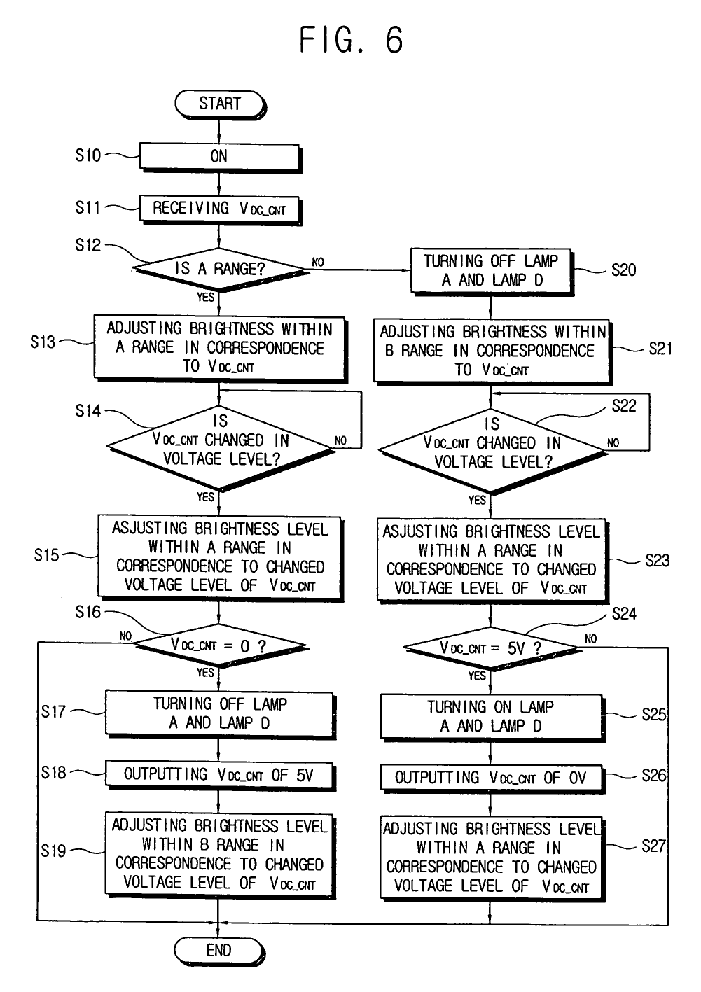

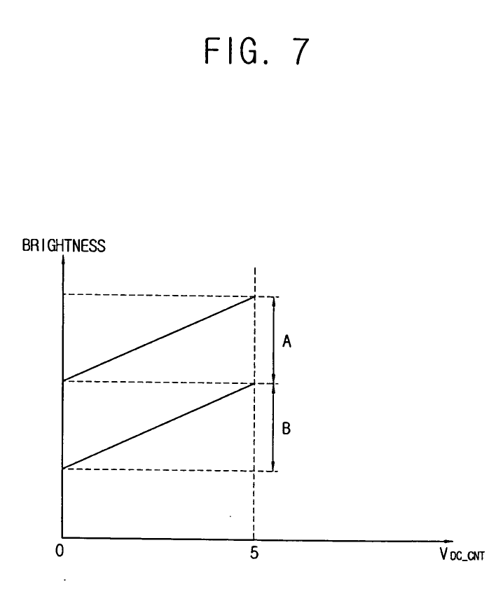

A method of controlling an LCD according to an embodiment of the present invention will be described with reference to FIGS. 6 and 7. In FIG. 7, an “A” range refers to a state when the lamp A 30a, the lamp B 30b, the lamp C 30c, and the lamp D 30d are all turned on, and a “B” range refers to a state when the lamp A 30a and the lamp D 30d are turned off.

Referring to FIGS. 4 through 7, at operation S10, the LCD is turned on. Then, at operation S11, the brightness adjuster 50 outputs the brightness-adjusting signal V_{DC}_{_{—}}_{CNT} having a preset voltage level to the controller 48 or 48′. At operation S12, the controller 48 or 48′ checks whether the voltage level of the brightness-adjusting signal V_{DC}_{_{—}}_{CNT} is included in the “A” range or the “B” range (refer to FIG. 7). Here, the controller 48 or 48′ uses information about the brightness level that corresponds to the voltage level of the brightness-adjusting signal V_{DC}_{_{—}}_{CNT} included in the “A” range or the “B” range, and stores the information therein when the LCD is turned off. The information may non-volatile information stored in a ROM.

In the case where the voltage level of the brightness-adjusting signal V_{DC}_{_{—}}_{CNT} is included in the “A” range, at operation S13, the controller 48 or 48′ controls the first lamp driver 41 and the second lamp driver 45 to make the LCD panel 1 have the brightness level corresponding to the voltage level of the brightness-adjusting signal V_{DC}_{_{—}}_{CNT}. That is, the lamp A 30a, the lamp B 30b, the lamp C 30c and the lamp D 30d are all turned on, and the brightness level is adjustable within the “A” range (refer to FIG. 7).

At operation S14, the controller 48 or 48′ checks whether the voltage level of the brightness-adjusting signal V_{DC}_{_{—}}_{CNT} is changed due to the brightness adjustment of a user. When the voltage level of the brightness-adjusting signal V_{DC}_{_{—}}_{CNT} is changed, at operation S15, the brightness level of the LCD panel 1 is adjusted to correspond to the voltage level of the brightness-adjusting signal V_{DC}_{_{—}}_{CNT} changed within the “A” range.

At operation S16, when the controller 48 or 48′ senses that the voltage level of the brightness-adjusting signal V_{DC}_{_{—}}_{CNT} is dropped into 0V, at operation S17, the controller 48 or 48′ controls the first lamp driver 41 to turn off the lamp A 30a and the lamp D 30d. Further, at operation S18, the brightness adjuster 50 adjusts the voltage level of the brightness-adjusting signal V_{DC}_{_{—}}_{CNT} from 0V to 5V. Here, the brightness adjuster 50 can adjust the voltage level of the brightness-adjusting signal V_{DC}_{_{—}}_{CNT} from 0V to 5V on the basis of the information that corresponds to the lamp A 30a and the lamp D 30d being turned off, received from the controller 48 or 48′. Alternately, the brightness adjuster 50 can adjust the voltage level of the brightness-adjusting signal V_{DC}_{_{—}}_{CNT} from 0V to 5V by sensing when the voltage level of the brightness-adjusting signal V_{DC}_{_{—}}_{CNT} is dropped into 0V.

At operation S19, the controller 48 or 48′ controls the brightness level of the LCD panel 1 to correspond to the voltage level of the brightness-adjusting signal V_{DC}_{_{—}}_{CNT} changed again from 5V within the “B” range (refer to FIG. 7) according to the brightness adjustment of the user.

On the other hand, in the case where the controller 48 or 48′ determines that the voltage level of the brightness-adjusting signal V_{DC}_{_{—}}_{CNT} is included in the “B” range, at operation S20, the controller 48 or 48′ controls the first lamp driver 41 to turn off the lamp A30a and the lamp D 30d. Then, at operation S21, the controller 48 or 48′ controls the second lamp driver 45 to control the LCD panel 1 to have the brightness level corresponding to the voltage level of the brightness-adjusting signal V_{DC}_{_{—}}_{CNT} within the “B” range (refer to FIG. 7).

At operation S22, the controller 48 or 48′ checks whether the voltage level of the brightness-adjusting signal V_{DC}_{_{—}}_{CNT} is changed due to the brightness adjustment of the user. When the voltage level of the brightness-adjusting signal V_{DC}_{_{—}}_{CNT} is changed, at operation S23, the brightness of the LCD panel 1 is adjusted to correspond to the voltage level of the brightness-adjusting signal V_{DC}_{_{—}}_{CNT} changed within the “B” range.

At operation S24, when the controller 48 or 48′ senses that the brightness-adjusting signal V_{DC}_{_{—}}_{CNT} has a voltage level of 5V, the controller 48 controls the first lamp driver 41 to turn on the lamp A 30a and the lamp D 30d at operation S25. Further, at operation S26, the brightness adjuster 50 adjusts the voltage level of the brightness-adjusting signal V_{DC}_{_{—}}_{CNT} from 5V to 0V. Here, the brightness adjuster 50 can adjust the voltage level of the brightness-adjusting signal V_{DC}_{_{—}}_{CNT} from 5V to 0V on the basis of the information that corresponds to the lamp A 30a and the lamp D 30d being turned on, received from the controller 48. Alternately, the brightness adjuster 50 can adjust the voltage level of the brightness-adjusting signal V_{DC}_{_{—}}_{CNT} from 5V to 0V by sensing when the brightness-adjusting signal V_{DC}_{_{—}}_{CNT} has a voltage level of 5V.

At operation S27, the controller 48 or 48′ controls the brightness level of the LCD panel 1 to correspond to the voltage level of the brightness-adjusting signal V_{DC}_{_{—}}_{CNT} changed again from 0V within the “A” range (refer to FIG. 7) according to the brightness adjustment of the user.

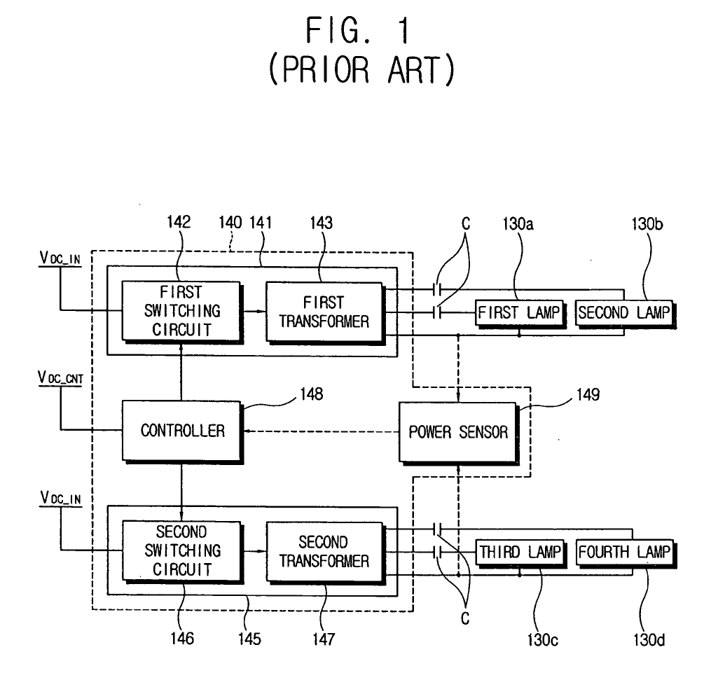

Thus, as shown in FIG. 7, the user adjustable brightness level range of the LCD panel 1 is expanded with respect to the same voltage level range of the brightness-adjusting signal V_{DC}_{_{—}}_{CNT} as compared with a conventional LCD of FIG. 1.

Meanwhile, in FIGS. 4 and 5, a power sensor 49 senses each current intensity of the first AC power and the second AC power. Here, the controller 48 or 48′ can compensate each current intensity of the first AC power and the second AC power on the basis of a sensed signal from the power sensor 49.

In the foregoing embodiment, each of the first lamp unit 30′ and the second lamp unit 30″ comprises two lamps. However, each of the first and second lamps may comprise three or more lamps. In a case where each of the first and second lamps comprises three or more lamps, the LCD can be configured to turn off an equal number of the lamps in each of the first lamp and the second lamp unit 30″, thereby having the same effect as the foregoing embodiments.

Thus, there are provided the first lamp driver 41 or 41′ supplying a first AC power to drive at least one lamp of the first lamp unit 30′ and at least one lamp of the second lamp unit 30″, the second lamp driver 45 supplying the second AC power to drive the other lamps of the first lamp unit 30′, and the other lamps of the second lamp 30′; and the controller 48 or 48′ to switch on/off supply of the first AC power, thereby expanding the user adjustable brightness level range of the LCD panel 1.

As described above, the present general inventive concept provides an LCD and a control method thereof, in which a user adjustable brightness level range of an LCD panel is expanded.

Although a few embodiments of the present invention have been shown and described, it will be appreciated by those skilled in the art that changes may be made in these embodiments without departing from the principles and spirit of the invention, the scope of which is defined in the appended claims and their equivalents.

1. An LCD comprising:
an LCD panel to display a picture thereon;
a backlight unit disposed in a rear of the LCD panel and comprising a light guide unit to guide light toward the LCD panel, and first and second lamp units respectively disposed at opposite edges of the light guide unit and each having two lamps to emit the light toward the light guide unit;
a first lamp driver to supply a first AC power to drive one lamp of the first lamp unit and one lamp of the second lamp unit; and
a second lamp driver to supply a second AC power to drive the other lamp of the first lamp unit and the other lamp of the second lamp unit.

2. The LCD according to claim 1, further comprising:
a controller to switch on/off supply of the first AC power.

3. The LCD according to claim 2, wherein the first lamp driver comprises: a switching circuit to output a pulse signal by switching on/off an input DC power, a first transformer to receive the pulse signal from the switching circuit and to generate the first AC power, and a switch to switch on/off the DC power being inputted to the switching circuit, and
the controller controls the switch to cut off the DC power being inputted to the switching circuit when the brightness-adjusting signal of the brightness adjuster is below the predetermined brightness level.

4. The LCD according to claim 3, wherein the controller controls a current intensity of at least one of the first AC power and the second AC power in correspondence to the brightness-adjusting signal outputted from the brightness adjuster and adjusts the brightness level of the LCD panel.

5. The LCD according to claim 2, further comprising:
a brightness adjuster to output a brightness-adjusting signal to adjust a brightness level of the LCD panel,
wherein the controller cuts off the supply of the first AC power when the brightness-adjusting signal of the brightness adjuster is below a predetermined brightness level.

6. The LCD according to claim 5, wherein the first lamp driver comprises a switching circuit to output a pulse signal by switching on/off an input DC power, and a first transformer to receive the pulse signal from the switching circuit and to generate the first AC power, and
the controller cuts off the pulse signal outputted from the switching circuit when the brightness-adjusting signal of the brightness adjuster is below the predetermined brightness level.

7. The LCD according to claim 6, wherein the controller controls a current intensity of at least one of the first AC power and second AC power in correspondence to the brightness-adjusting signal outputted from the brightness adjuster and adjusts the brightness level of the LCD panel.

8. The LCD according to claim 6, wherein:
the second lamp driver comprises a second switching circuit to output a second pulse signal by switching on/off the input DC power, and a second transformer to receive the second pulse signal from the second switching circuit and to generate the second AC power; and
the controller generates a first PWM signal to control the first switching circuit and a second PWM signal to control the second switching circuit.

9. The LCD according to claim 1, wherein the one lamp of the first lamp unit and the other lamp of the second lamp unit are disposed on a plane parallel to the LCD panel.

10. The LCD according to claim 1, wherein the one lamp of the first lamp unit and the one lamp of the second lamp unit are not disposed on a plane parallel to a major surface of the LCD panel.

11. The LCD according to claim 1, further comprising:
a controller to output pulse signals to control the first lamp driver, and to selectively control the first lamp driver to prevent the first AC power from being supplied to the first and second lamp units, without outputting the pulse signals.

12. The LCD according to claim 1, further comprising:
a DC power source;
a switch disposed between the DC power source and the first lamp driver; and
a controller to control the switch so that a DC power of the DC power source is not supplied to the first lamp driver while the DC power is supplied to the second lamp driver.

13. The LCD according to claim 1, further comprising:
a power sensor disposed between the first lamp unit and the first lamp driver to sense a brightness of the LCD panel; and
a controller to generate pulse signals to control levels of the first and second AC powers according to the sensed brightness of the LCD panel.

14. The LCD according to claim 13, wherein the controller terminates the supply of the first AC power from the first lamp driver to the first lamp unit and the second lamp unit according to the sensed brightness of the LCD panel.

15. A method of controlling an LCD comprising an LCD panel to display a picture thereon, and a backlight unit disposed in a rear of the LCD panel and comprising a light guide unit to guide light toward the LCD panel, and first and second lamp units respectively disposed at opposite edges of the light guide unit and each having at least two lamps to emit the light toward the light guide unit, the method comprising:
supplying a first AC power to one lamp of the first lamp unit and at least one lamp of the second lamp unit to drive the one lamp of the first lamp unit and the one lamp of the second lamp unit;
supplying a second AC power to the other lamp of the first lamp unit and the other lamp of the second lamp unit to drive the other lamp of the first lamp unit and the other lamp of the second lamp unit;
outputting a brightness-adjusting signal to adjust a brightness level of the LCD panel; and
cutting off the first AC power supplied to the one lamp of the first lamp and the one lamp of the second lamp when the brightness-adjusting signal is below a predetermined brightness level.

16. The method according to claim 15, further comprising:
adjusting a current intensity of at least one of the first AC power and the second AC power in correspondence to the brightness-adjusting signal.

17. The method according to claim 15, wherein the supplying of the first AC power comprises cutting on/off an input DC power to a first switching unit to switch on/off the first AC power.

18. The method according to claim 15, further comprising:
storing non-volatile information that corresponding to the brightness level of the LCD panel with a voltage level of the brightness-adjusting signal.

19. The method according to claim 15, wherein the outputting of the brightness-adjusting signal comprises turning at least on of the lamps.

20. An LCD comprising:
an edge type backlight unit having first and second lamps respectively disposed at opposite edges and having at least two lamps; and
a control unit controlling the same number of lamps to be turned on/off in the first and second lamp units.

21. The LCD according to claim 20, wherein:
the at least two lamps comprise one or more first lamps and one or more second lamps; and
the control unit comprises:
a first lamp driver to supply a first AC power to drive the one or more first lamps of the first lamp unit and the one or more first lamps of the second lamp unit, so that the number of the one or more first lamps of the first lamp unit supplied with the first AC power is the same as that of the one or more first lamps of the second lamp unit supplied with the first AC power;
a second lamp driver to supply a second AC power to drive the one or more second lamps of the first lamp unit and the one or more second lamps of the second lamp unit, so that the number of the one or more second lamps of the first lamp unit supplied with the second AC power is the same as that of the one or more second lamps of the second lamp unit; and
a controller switching on/off supply of the first AC power so as to control the same number of lamps to be turned on/off in the first and second lamp units.

22. A method of controlling an LCD comprising an edge type backlight unit having a first and second lamps respectively disposed at opposite edges and each having at least two lamps, the method comprising:
controlling the same number of lamps to be turned on/off in the first and second lamp units.

23. The method according to claim 22, wherein:
the lamps comprise one or more first lamps and one or more second lamps; and
the controlling of the same number of lamps comprises:
supplying a first AC power to drive the one or more first lamps of the first lamp unit and the one or more first lamps of the second lamp unit, so that the number of the one or more first lamps of the first lamp unit supplied with the first AC power is the same as that of the one or more first lamps of the second lamp unit supplied with the first AC power;
supplying a second AC power to drive the one or more second lamps of the first lamp unit and the one or more second lamps of the second lamp unit, so that the number of the one or more second lamps of the first lamp unit supplied with the second AC power is the same as that of the one or more second lamps of the second lamp unit; and
switching on/off supply of the first AC power so as to control the same number of lamps to be turned on/off in the first and second lamp units.
